(19) United States
(12) Patent Application Publication
(10) Pub. No.: US 2017/0034626 A1
(43) Pub. Date: Feb. 2, 2017

(54) SPEAKER

(71) Applicants: Guqing Zhang, Shenzhen (CN); Jiasheng Zhou, Shenzhen (CN)

(72) Inventors: Guqing Zhang, Shenzhen (CN); Jiasheng Zhou, Shenzhen (CN)

(73) Assignee: AAC Technologies Pte. Ltd., Singapore (SG)

(21) Appl. No.: 15/061,063

(22) Filed: Mar. 4, 2016

(30) Foreign Application Priority Data
Jul. 31, 2015 (CN) 201520572966.2

(51) Int. Cl. H04R 9/02; H04R 9/06

(52) U.S. Cl. CPC H04R 9/025; H04R 9/06; H04R 2499/11; H04R 2209/027

(57) ABSTRACT

A speaker is provided in the present disclosure. The speaker includes a holder, a magnetic system received in the holder, a vibration system having a membrane and a voice coil for driving the membrane to vibrate, and an elastic member for suspending the magnetic system in the holder and enabling the magnetic system to vibrate along a vibration direction of the membrane. The elastic member includes a supporting part for supporting the magnetic system, a plurality of elastic arms extending from the supporting part, and a plurality of fixing parts fixed to the holder. Each of the elastic arms extends in a plane perpendicular to the vibration direction of the membrane in a wavy manner.

### FIELD OF THE DISCLOSURE

The present disclosure relates to electro-acoustic converting technologies, and more particularly, to a speaker applicable to a mobile device for producing audible sound.

### BACKGROUND

Speakers are widely applied in mobile devices, such as mobile phones, tablet computers or laptop computers, for converting electrical signals into audible sounds. A related speaker includes a vibration system with a membrane, a magnetic system, a holder and an elastic member. The magnetic system is suspended in the holder by the elastic member, and the elastic member enables the magnetic system to vibrate along a vibration direction of the membrane.

Typically, the elastic member includes a supporting part for supporting the magnetic system, and a plurality of elastic arms extending from the supporting part; each of the elastic arms has an elongated and straight configuration. However, when the speaker is dropped off or suffers collision, the elongated elastic arms may need to endure an impact force perpendicular to the vibration direction without any buffer structure. This may cause the elastic member to be damaged, and further reduce an acoustic performance and a reliability of the speaker.

Therefore, it is desired to provide a new speaker which can overcome the aforesaid problems.

### BRIEF DESCRIPTION OF THE DRAWINGS

Many aspects of the embodiment can be better understood with reference to the following drawings. The components in the drawing are not necessarily drawn to scale, the emphasis instead being placed upon clearly illustrating the principles of the present disclosure. Moreover, in the drawings, like reference numerals designate corresponding parts throughout the several views.

FIG. 1 is an exploded view of a speaker according to a first embodiment of the present disclosure;

FIG. 2 is a schematic view of an elastic member of the speaker of FIG. 1;

FIG. 3 is an assembled view of a vibration system, a magnetic system and the elastic member of the speaker of FIG. 1;

FIG. 4 is an assembled view of a holder and the elastic member of the speaker of FIG. 1.

### DETAILED DESCRIPTION

The present disclosure will be described in detail below with reference to the attached drawings and the embodiment thereof.

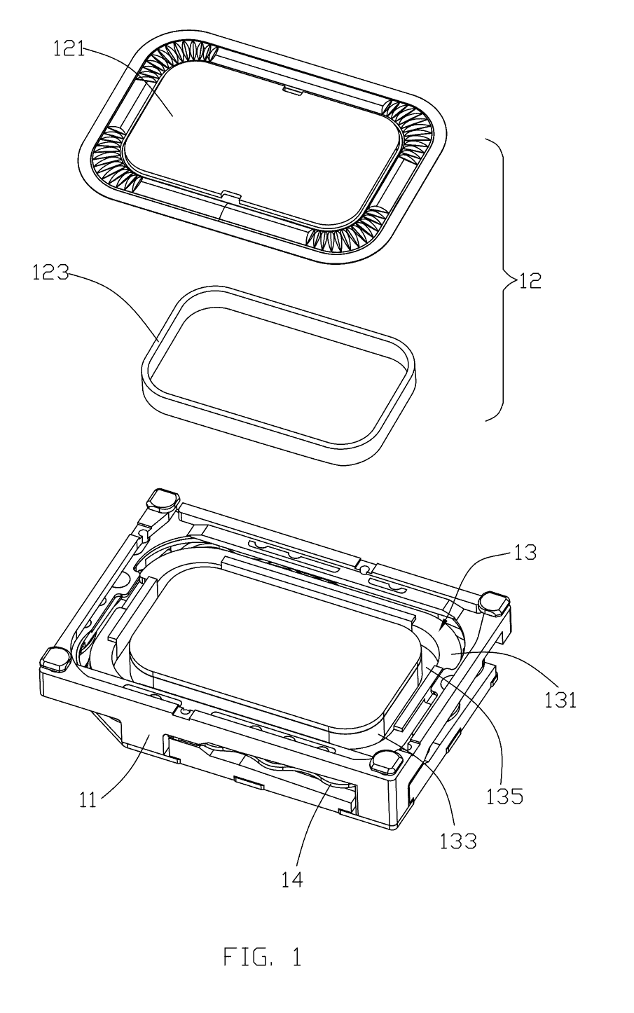

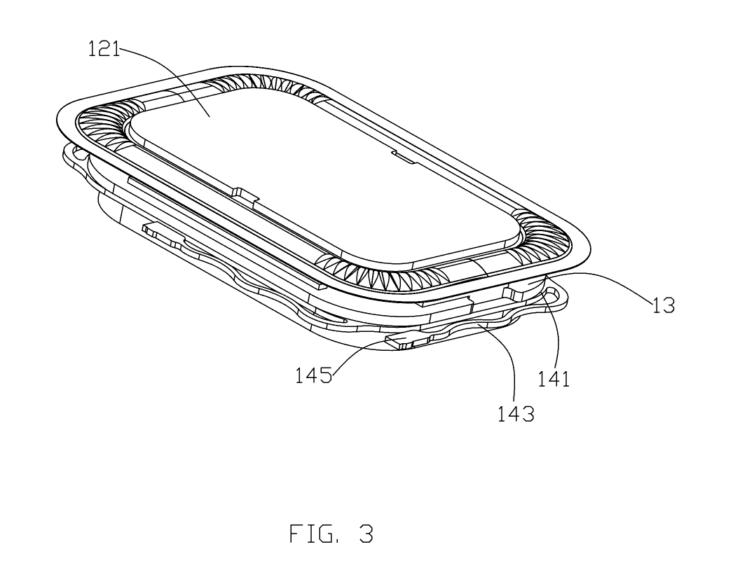

Referring to FIGS. 1-4, a speaker 1 according to an embodiment of the present disclosure is shown. The speaker 1 may be a micro speaker applicable to a mobile device such as a mobile phone, a personal digital assistant, a tablet computer, a laptop computer, or the like. The speaker 1 includes a holder 11, a vibration system 12, a magnetic system 13 and an elastic member 14.

The holder 11 provides a receiving space for receiving the vibration system 12 and the magnetic system 13. The vibration system 12 includes a membrane 121 and a voice coil 123 for driving the membrane to vibrate and generate audible sound. The magnetic system 13 includes a yoke 131 with a plurality of sidewalls, and a magnet 133 received in the yoke 131. The magnet 133 is spaced apart from the sidewalls of the yoke 131 to form a magnetic gap 135 between the magnet 133 and the yoke 131. The voice coil 123 is connected to the membrane 121, and is suspended in the magnetic gap 135.

The magnetic system 13 is supported and suspended in the holder 11 by the elastic member 14, and the elastic member 14 enables the magnetic system 13 to vibrate along a vibration direction of the membrane 121. Specifically, the elastic member 14 includes a supporting part 141 for supporting the magnetic system 13, a plurality of elastic arms 143 extending from the supporting part 141, and a plurality of fixing parts 145 each of which is formed at an end of a respective elastic arm 143 and fixed to the holder 11.

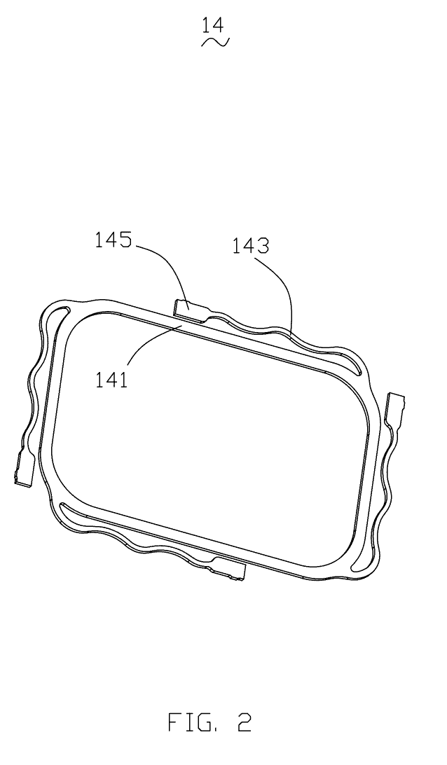

As illustrated in FIG. 2, the supporting part 141 of the elastic member 14 may a rectangular supporting ring with four rims connected end to end, and the elastic member 14 includes four elastic arms 143 respectively extending from four corner of the supporting part 141. Each of the elastic arms 143 extends rightwards substantially along an adjacent rim of the supporting part 141. The fixing parts 145 are respectively formed at the ends of the elastic arms 143 and are further fixed to the holder 11.

In the present embodiment, each of the elastic arms 143 is in a wavy shape, which extends in a plane perpendicular to the vibration direction of the membrane 121 in a wavy manner. For example, each of the elastic arms 143 may be a W-shaped arm, a V-shaped arm, or an S-shaped arm. The elastic arms 143 in the wavy shape enable the elastic member 14 to deform elastically perpendicular to the vibration direction of the membrane 121.

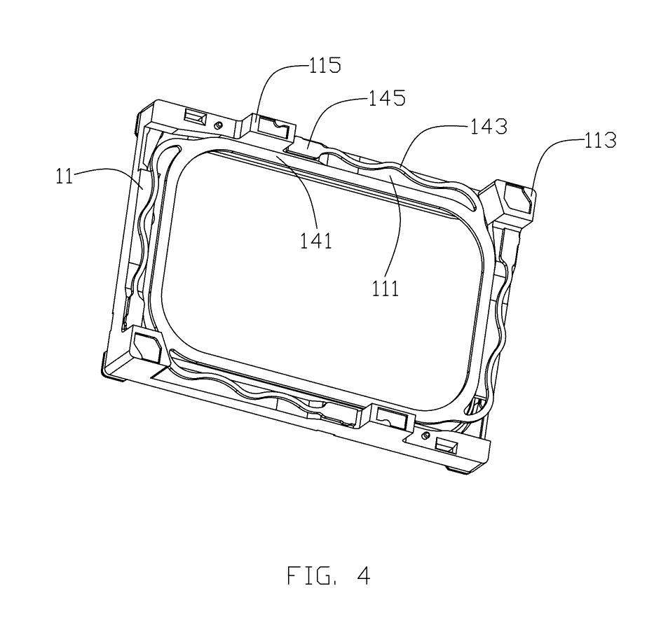

As illustrated in FIG. 4, the holder 11 includes a main body 111, a pair of first extending parts 113 and a pair of second extending parts 115. The first extending parts 113 and the second extending parts 115 may extend perpendicularly from a bottom surface of the main body 111. The first extending parts 113 are formed at two diagonal corners of the main body 111 respectively, and the second extending parts 115 are formed spaced apart from the first extending parts 113.

The elastic member 14 may be installed on the holder 11; each of the fixing parts 145 thereof is fixed to the main body 111, and is adjacent to a respective one of the first extending parts 143 and the second extending parts 145. A projection of the elastic arms 143 along the vibration direction of the membrane 121 is at least partly located on the main body 111.

In the speaker 1 as provided in the present disclosure, the elastic arms 143 of the elastic member 14 have a wavy configuration to enable the elastic member 14 to deform elastically perpendicular to the vibration direction of the membrane 121. With this configuration, the elastic member 14 is capable of buffering an impact force perpendicular to the vibration direction when the speaker 1 is dropped off or suffers collision; therefore, an acoustic performance and a reliability of the speaker 1 can be improved.

It is to be understood, however, that even though numerous characteristics and advantages of the present embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A speaker, comprising:
a holder;
a magnetic system received in the holder;
a vibration system comprising a membrane and a voice coil for driving the membrane to vibrate; and
an elastic member for suspending the magnetic system in the holder and enabling the magnetic system to vibrate along a vibration direction of the membrane;
wherein the elastic member comprises a supporting part for supporting the magnetic system, a plurality of elastic arms extending from the supporting part, and a plurality of fixing parts fixed to the holder; each of the elastic arms extends in a plane perpendicular to the vibration direction of the membrane in a wavy manner.

2. The speaker of claim 1, wherein the elastic arms are configured for enabling the elastic member to deform elastically perpendicular to the vibration direction of the membrane.

3. The speaker of claim 2, wherein each of the elastic arm is a W-shaped arm, a V-shaped arm, or an S-shaped arm.

4. The speaker of claim 1, wherein each of the fixing parts of the elastic member is formed at an end of a respective elastic arm of the elastic member.

5. The speaker of claim 4, wherein the holder comprises a main body, a pair of first extending parts and a pair of second extending parts; the first extending parts and the second extending parts extend perpendicularly from the main body.

6. The speaker of claim 5, wherein the first extending parts are formed at two diagonal corners of the main body respectively, and the second extending parts are formed spaced apart from the first extending parts.

7. The speaker of claim 6, wherein each of the fixing parts of the elastic member is fixed to the main body, and is adjacent to a respective one of the first extending parts and the second extending parts.

8. The speaker of claim 7, wherein a projection of the elastic arms along the vibration direction of the membrane is at least partly located on the main body.

9. The speaker of claim 1, wherein the supporting part of the elastic member is a rectangular supporting ring with four rims connected end to end, and the plurality of elastic arms respectively extend from four corner of the supporting part.

10. The speaker of claim 9, wherein each of the elastic arms extends rightwards substantially along an adjacent rim of the supporting part.

11. The speaker of claim 1, wherein the magnetic system comprises a yoke and a magnet received in the yoke.

12. The speaker of claim 1, wherein the magnet is spaced apart from the yoke to form a magnetic gap, and the voice coil is suspended in the magnetic gap.
